(19) United States
(12) Patent Application Publication
(10) Pub. No.: US 2020/0301338 A1
(43) Pub. Date: Sep. 24, 2020

(54) IMAGE FORMING APPARATUS

(71) Applicant: Konica Minolta Inc., Tokyo (JP)

(72) Inventor: Yu MUKOBAYASHI, Toyokawa-shi (JP)

(21) Appl. No.: 16/812,223

(22) Filed: Mar. 6, 2020

(30) Foreign Application Priority Data
Mar. 18, 2019 (JP) 2019-049784

(51) Int. Cl. G03G 15/00; G03G 15/043; G03G 15/05

(52) U.S. Cl. CPC G03G 15/556; G03G 15/505; G03G 2215/00059; G03G 15/05; G03G 15/043

(57) ABSTRACT

An image forming apparatus includes: a photoreceptor that forms a toner image on a surface of the photoreceptor; a charger that charges the surface of the photoreceptor; an exposure device that exposes the surface of the photoreceptor; a developer that supplies toner to the surface of the photoreceptor; an intermediate transfer belt for transferring the toner image formed on the surface of the photoreceptor; a density sensor that detects a density of the toner image on the intermediate transfer belt; and a controller that controls the image forming apparatus.

The entire disclosure of Japanese patent Application No. 2019-049784, filed on Mar. 18, 2019, is incorporated herein by reference in its entirety.

### BACKGROUND

### Technological Field

The present disclosure relates to an image forming apparatus, and more specifically, to lifetime prediction of a photoreceptor.

### Description of the Related Art

In a photoreceptor of an image forming apparatus, image noise due to wear of a surface of the photoreceptor is a bottleneck that reduces the printable number of sheets of the photoreceptor. In recent years, in order to increase the printable number of sheets of the photoreceptor, a super-hard photoreceptor provided with an overcoat layer (hereinafter referred to as “OCL”) on an outermost surface of the photoreceptor is often employed.

By providing the OCL on the photoreceptor, it is possible to suppress wear of a surface layer of the photoreceptor and to increase the printable number of sheets several times that with the conventional photoreceptor.

On the other hand, when the OCL becomes thick, reproducibility of a thin line of a toner image might be deteriorated or a line width might increase. This is because, when the surface of the photoreceptor is negatively charged, positive charges inside the photoreceptor flow in a lateral direction. The thicker the OCL, the easier the positive charges flow laterally. In order to suppress a phenomenon that the positive charges flow laterally, the OCL needs to be thinner than the surface layer of the conventional photoreceptor.

The thin OCL layer means that the super-hard photoreceptor provided with the OCL has a smaller wear margin on the surface of the photoreceptor than that of the conventional photoreceptor. If the wear allowance is small, conventional film thickness measurement based on charging current detection cannot be applied. This is because the change in the charging current is too small because the wear of the surface layer is small. However, in order to estimate the remaining printable number of sheets of the photoreceptor, it is necessary to measure the film thickness of the surface layer of the photoreceptor. Therefore, a technology of estimating the film thickness of the super-hard photoreceptor provided with the OCL is required.

Regarding the estimation of the film thickness of the photoreceptor, for example, JP 2017-049278 A (JP 2017-049278 A) discloses an image forming apparatus in which “a controller includes an arithmetic device which stores relationship information regarding a relationship between a film thickness of a first photoreceptor and a charging current by using an initial film thickness of the first photoreceptor stored in a memory, a change in film thickness of the first photoreceptor calculated by a calculator, and a change in charging current detected by a charging current detecting circuit, and calculates a film thickness of a second photoreceptor based on the relationship information when the first photoreceptor is detached from a main body and the second photoreceptor other than the first photoreceptor is mounted on the main body” (refer to “Abstract”).

Other technologies relating to estimation of a degree of deterioration and film thickness of the photoreceptor are disclosed in, for example, JP 2007-187734 A, JP 2005-0 17970 A, JP 2017-207618 A, JP 2013-120261 A, JP 02-235073 A, and JP 2004-354485 A.

According to the technologies disclosed in JP 2017-049278 A, JP 2007-187734 A, JP 2005-017970 A, JP 2017-207618 A, JP 2013-120261 A, JP 02-235073 A, and JP 2004-354485 A, it is not possible to appropriately estimate the film thickness of a super-hard photoreceptor in which the thickness of the OCL vanes at the time of manufacture. Therefore, there is a need for a technology for appropriately estimating the film thickness of the super-hard photoreceptor that causes variation in OCL thickness at the time of manufacture.

### SUMMARY

The present disclosure is achieved in view of the background as described above, and an object in one aspect thereof is to provide a technology for appropriately estimating the film thickness and life of the super-hard photoreceptor in which variation occur in the thickness of the OCL at the time of manufacture.

To achieve the abovementioned object, according to an aspect of the present invention, an image forming apparatus reflecting one aspect of the present invention comprises: a photoreceptor that forms a toner image on a surface of the photoreceptor, a charger that charges the surface of the photoreceptor, an exposure device that exposes the surface of the photoreceptor; a developer that supplies toner to the surface of the photoreceptor, an intermediate transfer belt for transferring the toner image formed on the surface of the photoreceptor, a density sensor that detects a density of the toner image on the intermediate transfer belt; and a controller that controls the image forming apparatus, wherein the controller changes a light amount of the exposure device a plurality of times to expose a plurality of parts on the surface of the photoreceptor with different light amounts, allows the developer to form toner images for inspection for respective parts on the surface of the photoreceptor exposed with the different light amounts, detects densities of the toner images for inspection transferred to the intermediate transfer belt based on an output from the density sensor, and compares the densities of the respective toner images for inspection to estimate a life of the photoreceptor based on a change amount of the densities of the toner images for inspection caused by a change in light amount of the exposure device.

### BRIEF DESCRIPTION OF THE DRAWINGS

The objects, advantages, aspects, and features provided by one or more embodiments of the invention will become more fully understood from the detailed description given hereinbelow and the appended drawings winch are given by way of illustration only, and thus are not intended as a definition of the limits of the present invention:

FIG. 1 is a view illustrating a configuration example of an image forming apparatus according to one embodiment;

FIG. 2 is a view illustrating an example of a relationship between an OCL film thickness and a line width of a toner image;

FIG. 3 is a view illustrating an example of a flow in a lateral direction of positive charges of a photoreceptor;

FIG. 4 is a view illustrating an example of a method of estimating a life of a conventional photoreceptor;

FIG. 5 is a view illustrating an example of characteristics of the conventional photoreceptor and a super-hard OCL photoreceptor provided with the OCL;

FIG. 6 is a view illustrating an example of life prediction using an intermediate transfer belt;

FIG. 7 is a view illustrating an example of a change amount of a density of the toner images of the photoreceptor when a PH light amount is changed;

FIG. 8 is a view illustrating an example of a relationship between the OCL film thickness, the change amount of the density of the toner images when the PH light amount is changed, and the life of the photoreceptor;

FIG. 9 is a view illustrating an example of an estimated life of the photoreceptor;

FIG. 10 is a view illustrating an example of a relationship between a rotational speed of the photoreceptor and an inclination (change amount of the density of the toner images when the PH light amount is changed);

FIG. 11 is a view illustrating an example of a process of the life prediction of the photoreceptor;

FIG. 12 is a view illustrating an example of a state in which the photoreceptor charged with different voltages is exposed;

FIG. 13 is a view illustrating an example of the change amount of the density of the toner images on the photoreceptor when the charging potential of the photoreceptor is changed;

FIG. 14 is a view illustrating an example of a relationship between the OCL film thickness, the change amount of the density of the toner images when the charging potential of the photoreceptor is changed, and the life of the photoreceptor;

FIG. 15 is a view illustrating an example of the process of the life prediction of the photoreceptor;

FIG. 16 is a view illustrating an example of an effect of the change in volume resistance of the OCL for each environment;

FIG. 17 is a view illustrating an example of a correlation among the OCL film thickness, the inclination for each environment, and the life of the photoreceptor; and

FIG. 18 is a view illustrating an example of a method of estimating the life of the photoreceptor according to one embodiment.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same components are assigned with the same reference numerals. Their names and functions are also the same. Therefore, detailed description thereof is not repeated.

### First Embodiment

First, an application configuration of an image forming apparatus 100 according to this embodiment is described. Hereinafter, as a typical example, the image forming apparatus 100 mounted as a multi-functional peripheral (MFP) is described. The image forming apparatus 100 is, for example, a color image forming apparatus, but an application target of the technological thought according to this embodiment is not limited to the color image forming apparatus, and the technological thought is also applicable to a monochrome image forming apparatus.

In the following description, a remaining film thickness of a surface layer of a photoreceptor or the remaining printable number of sheets of the photoreceptor is collectively referred to as a “life”. Estimation of the film thickness of the photoreceptor or estimation of the remaining printable number of sheets of the photoreceptor is collectively referred to as “life prediction”.

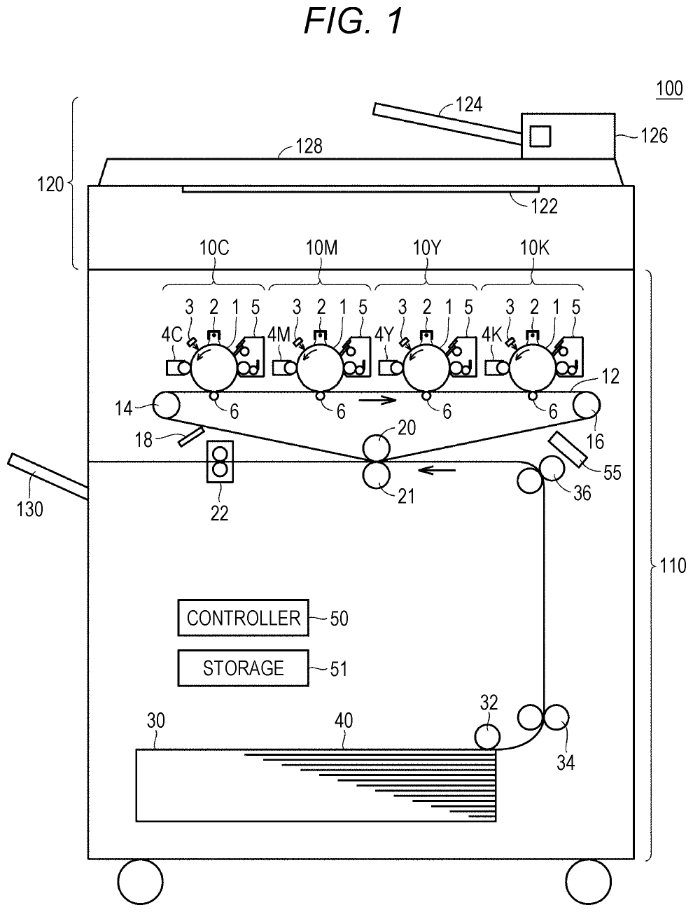

FIG. 1 is a view illustrating a configuration example of the image forming apparatus 100 according to this embodiment. With reference to FIG. 1, the image forming apparatus 100 includes a print engine 110, a document reader 120, and a discharge tray 130.

The print engine 110 includes imaging units 10C, 10M, 10Y, and 10K (hereinafter, sometimes collectively referred to as the “imaging units 10”) that form toner images of cyan (C), magenta (M), yellow (Y), and key plate (K), an intermediate transfer belt 12, intermediate transfer body driving rollers 14 and 16, a belt cleaner 18, transfer rollers 20 and 21, a fixer 22, a paper feeder 30, a delivery roller 32, conveyance rollers 34 and 36, a controller 50, a storage 51, and a density sensor 55. The imaging unit 10 includes a photoreceptor 1, a charger 2, an exposure device 3, and a developer 4 (4C, 4M, 4Y, or 4K corresponding to a color of the toner image formed by the corresponding imaging unit 10), a cleaner 5, and an intermediate transfer body contact roller 6. The document reader 120 includes an image scanner 122, a document feed table 124, an automatic document feeder 126, and a document discharge table 128.

The print engine 110 performs a printing process on a medium 40 in the paper feeder 30. The delivery roller 32 conveys the medium 40 from the paper feeder 30. Furthermore, the conveyance rollers 34 and 36 convey the medium 40 to the transfer rollers 20 and 21. The transfer rollers 20 and 21 transfer the toner image to the medium 40. The fixer 22 performs a fixing process on the medium 40. Finally, the medium 40 is discharged to the discharge tray 130.

Each imaging unit 10 and the intermediate transfer belt 12 form the toner image to be transferred to the medium 40. The charger 2 uniformly charges a surface of the photoreceptor 1. The exposure device 3 exposes the surface of the photoreceptor 1 according to a designated image pattern, thereby forming an electrostatic latent image on the surface by laser writing or the like. The developer 4 develops the electrostatic latent image formed on the photoreceptor 1 being an image carrier as the toner image. Note that, the surface layer of the photoreceptor 1 is provided with an OCL.

The toner image formed on the surface of the photoreceptor 1 is transferred to the intermediate transfer belt 12 by the intermediate transfer body contact roller 6. On the intermediate transfer belt 12, the toner images are sequentially transferred from the respective photoreceptors 1, and the toner images of four colors are superimposed. The superimposed toner image is transferred from the intermediate transfer belt 12 to the medium 40 by the transfer rollers 20 and 21. The density sensor 55 detects a density of the toner image on the intermediate transfer belt 12. In one aspect, an image density control (IDC) sensor may be used as the density sensor 55. In one aspect, the density sensor 55 may detect the density of the toner image on the surface of each photoreceptor 1 of the imaging unit 10.

The document reader 120 reads a document and outputs a read result as an input image to the print engine 110. The image scanner 122 scans the document arranged on a platen glass. The automatic document feeder 126 continuously scans the documents arranged on the document feed table 124. The documents arranged on the document feed table 124 are fed one by one by a delivery roller (not illustrated), and sequentially scanned by the image scanner 122 or an image sensor arranged in the automatic document feeder 126. The scanned document is discharged to the document discharge table 128.

The controller 50 controls an entire image forming apparatus 100. The storage 51 stores firmware and various settings of the image forming apparatus 100. The controller 50 refers to necessary data and programs from the storage 51.

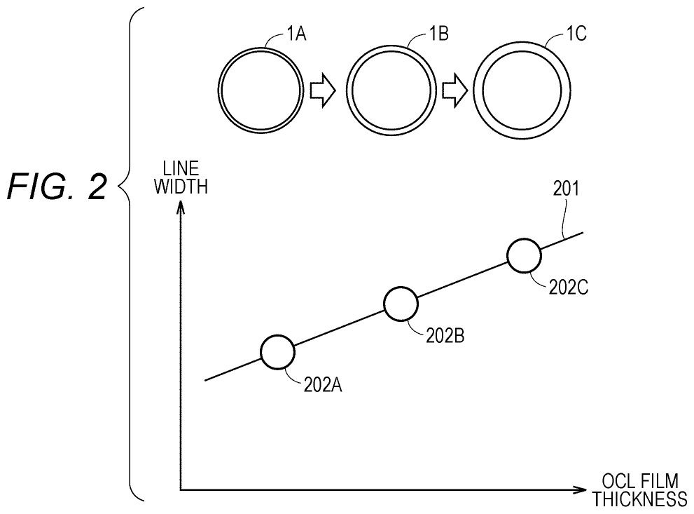

FIG. 2 is a view illustrating an example of a relationship between an OCL film thickness and a line width of the toner image. A graph 201 is a graph illustrating the relationship between the OCL film thickness and the line width of the toner image. As is understood from the graph 201, as the OCL film thickness increases, the line width of the toner image increases.

The OCL is provided on the surface layer of photoreceptors 1A, 1B, and 1C. Among the photoreceptors 1A, 1B, and 1C, the OCL of the photoreceptor 1A has a minimum film thickness, the OCL of the photoreceptor 1B has a second minimum film thickness, and the OCL of the photoreceptor 1C has a maximum film thickness. The line widths in a case where the same toner image is formed on the photoreceptors 1A, 1B, and 1C are, for example, indicated by points 202A, 202B, and 202C, respectively.

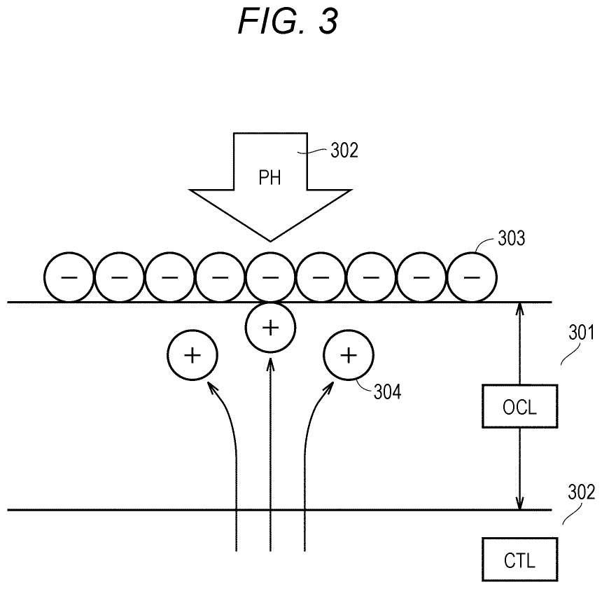

FIG. 3 is a view illustrating an example of a flow in a lateral direction of positive charges of the photoreceptor 1. The photoreceptor 1 includes an OCL 301 in the surface layer, and a charge transport layer (CTL) 302 inside the photoreceptor 1. The exposure device 3 negatively charges the surface layer of the photoreceptor 1 by PH light 302. By doing so, negative charges 303 cover the surface layer of the photoreceptor 1. At that time, positive charges 304 inside the photoreceptor 1 gather on the surface layer, but slightly flow in the lateral direction. An amount of the positive charges 304 that flow laterally is proportional to a thickness of the OCL 301.

In a case where the developer 4 supplies toner to the photoreceptor 1 in a state in which the positive charges 304 flow laterally, a phenomenon occurs that the toner supplied to the photoreceptor 1 is attracted by the positive charges 304 that flow laterally to laterally spread on the photoreceptor 1, so that the line width of the toner image increases. Therefore, it is desirable that the OCL film thickness is small to some extent. However, there is a case where it becomes difficult to obtain the life of the photoreceptor 1 as the OCL film thickness decreases.

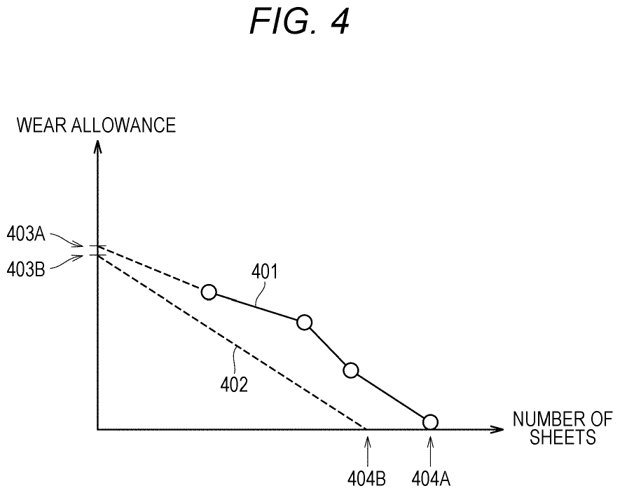

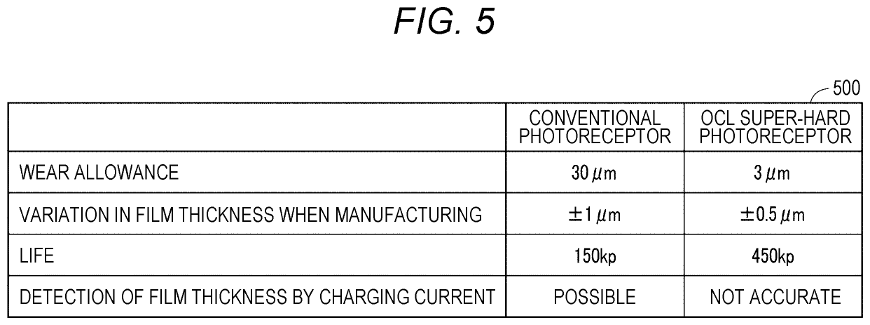

Next, with reference to FIGS. 4 and 5, a method of estimating the life of a conventional photoreceptor is described, then, a problem in a case where the method of estimating the life of the conventional photoreceptor is applied to the photoreceptor 1 provided with the OCL is described.

Note that, in the following description, for comparison, a conventional image forming apparatus is referred to as an “image forming apparatus A” in contrast to the image forming apparatus 100 according to this embodiment. The image forming apparatus 100 according to this embodiment includes a super-hard “photoreceptor 1” provided with the OCL, whereas the image forming apparatus A includes a conventional “photoreceptor B” that is not super hard with large wear allowance.

As a method of obtaining the life of the conventional photoreceptor B, there is a method of examining a charging current of the photoreceptor B. The charging current of the photoreceptor B changes in proportion to wear of the surface layer of the photoreceptor B. Therefore, the image forming apparatus A estimates a wear amount or the remaining printable number of sheets of the photoreceptor B by detecting the change in the charging current of the photoreceptor B.

FIG. 4 is a view illustrating an example of the method of estimating the life of the conventional photoreceptor B. With reference to FIG. 4, life prediction using the charging current of the photoreceptor B is described. A graph 401 illustrates life prediction of the photoreceptor B obtained by measuring the charging current each time the image forming apparatus A prints a certain number of media. A graph 402 illustrates life prediction of the conventional photoreceptor B in a case where this is assumed to be continuously used in the most severe situation assumed.

Points 403A and 403B indicate the wear allowance (film thickness of the surface layer of the photoreceptor B) when the photoreceptor B is new (when the number of printed sheets is 0) in the graphs 401 and 402, respectively. A difference in the wear allowances between the points 403A and 403B is variation in the wear allowance (film thickness) when the photoreceptor B is manufactured. Points 404A and 404B indicate a state in which the wear allowance of the photoreceptor B does not remain, that is, the photoreceptor B is used to its limit.

In the graph 402, the photoreceptor B is used in the most severe situation (the same print setting). Therefore, in the graph 402, the wear allowance decreases linearly as the number of printed sheets increases. On the other hand, in the graph 401, the photoreceptor B is used under different conditions (paper size, toner usage amount and the like) every time, so that the wear allowance does not decrease linearly in proportion to the number of printed sheets.

As described above, conventionally, the image forming apparatus A may set a minimum guaranteed value (the number of printed sheets at the point 404B) of the graph 402 or predict the life of the photoreceptor B by the charging current each time a certain number of sheets are printed, thereby estimating the remaining wear allowance or the remaining printable number of sheets of the photoreceptor B.

FIG. 5 is a view illustrating an example of characteristics of the conventional photoreceptor B and the super-hard OCL photoreceptor 1 provided with the OCL. The above-described “minimum guaranteed value” and “measurement using the charging current” are suitable for the life prediction of the conventional photoreceptor B, but are not suitable for the life prediction of the super-hard photoreceptor 1 provided with the OCL. A reason therefor is described with reference to FIG. 5.

As is understood from a table 500, the wear allowance of the conventional photoreceptor B is larger than that of the super-hard photoreceptor 1 provided with the OCL. That is, the photoreceptor B has a large change amount of the wear allowance between when the number of printed sheets is 0 (wear allowance=30 μm) and when the maximum printable number of sheets are printed (wear allowance=0 μm). Since the charging current of the photoreceptor B depends on the thickness of the wear allowance, the charging current of the photoreceptor B also changes significantly according to the change in the wear allowance. Therefore, the image forming apparatus A may predict the life of the photoreceptor B by detecting the change in the charging current of the photoreceptor B.

On the other hand, the photoreceptor 1 has a small change amount of the wear allowance between when the number of printed sheets is 0 (wear allowance=3 μm) and when the maximum printable number of sheets are printed (wear allowance=0 μm). Therefore, the change in the charging current of the photoreceptor 1 also decreases. Therefore, in the image forming apparatus 100, even when the change in the charging current of the photoreceptor 1 is detected, the change amount of the charging current is too small, so that the life of the photoreceptor 1 cannot be predicted.

In the photoreceptor 1, as compared with the photoreceptor B, an effect of the variation in the film thickness (wear allowance) at the time of manufacture and a measurement error of the wear allowance are significantly large. The photoreceptor B has the variation in the film thickness at the time of manufacture of “±1 μm”. The life per wear allowance “1 μm” of the photoreceptor B is “150/30=5 (kp/μm)”. Therefore, in the photoreceptor B, a difference of “1*5=±2.5 (kp)” might occur in the life due to individual difference.

On the other hand, in the photoreceptor 1, the variation in the film thickness at the time of manufacture is “±0.5 μm”. The life per wear allowance “1 μm” of the photoreceptor 1 is “450/3=150 (kp/μm)”. Therefore, in the photoreceptor 1, a difference of “0.5*150=±75 (kp)” might occur in the life due to individual difference.

As is understood from the above-described comparison, the life of the photoreceptor 1 varies significantly due to the variation at the time of manufacture. Since the printable number of sheets per wear allowance of “1 μm” is significantly larger than that of the photoreceptor B, the measurement error of the wear allowance due to the charging current has a significant effect.

From above, the super-hard photoreceptor 1 provided with the OCL has smaller wear allowance and a larger effect of the measurement error than those of the conventional photoreceptor B. Therefore, the life prediction of the photoreceptor 1 cannot be appropriately performed in the measurement of the wear allowance by the charging current.

In this embodiment, the image forming apparatus 100 utilizes a property that the positive charges inside the photoreceptor 1 spread laterally in proportion to the OCL film thickness and the PH light by the exposure device 3 in order to predict the life of the photoreceptor 1.

When a “light amount of the PH light” by the exposure device 3 changes, an “amount of the positive charges that laterally spread inside the photoreceptor 1” also changes. A change amount of the “amount of the positive charges that laterally spread inside the photoreceptor 1” based on the change in the “light amount of the PH light” varies depending on the “OCL film thickness”.

As described with reference to FIG. 3, the line width of the toner image increases as the positive charges inside the photoreceptor 1 spread laterally. Therefore, when the “light amount of the PH light” changes, the “amount of the positive charges that laterally spread inside the photoreceptor 1” also changes, and further, the “line width of the toner image” also changes. Utilizing this property, the image forming apparatus 100 may estimate the OCL film thickness by detecting the change amount of the “line width of the toner image” due to the change in the “light amount of the PH light”.

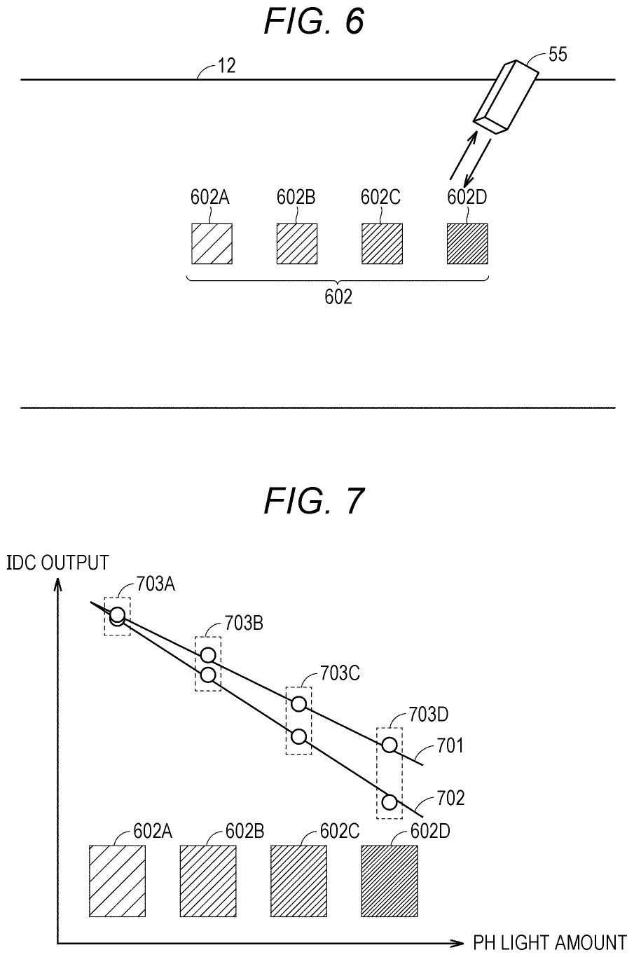

Next, with reference to FIGS. 6 to 8, the life prediction of the photoreceptor 1 utilizing the change in the light amount of the PH light is described. FIG. 6 is a view illustrating an example of the life prediction using the intermediate transfer belt 12.

In the example illustrated in FIG. 6, the image forming apparatus 100 transfers toner images 602A, 602B, 602C, and 602D (hereinafter, when they are collectively referred to, they are referred to as the “toner images 602”) that are toner images for inspection for examining the OCL film thickness on the intermediate transfer belt 12. The toner image 602 is formed of thin lines with a fixed number of dots. With the toner images 602A, 602B, 602C, and 602D, the PH light amount at the time of exposure of the photoreceptor 1 is different.

First, a procedure of forming the toner image 602 by the image forming apparatus 100 is described. The image forming apparatus 100 forms a plurality of toner images on the photoreceptor 1 that is a target of the life prediction. At that time, the controller 50 changes the PH light amount of the exposure device 3 stepwise to expose different parts on the photoreceptor 1 with different PH light amounts.

Next, the controller 50 allows the developer 4 to supply the toner to respective parts exposed with the different PH light amounts. Note that, the controller 50 allows the developer 4 to form the same toner image formed of the thin lines with the fixed number of dots in the respective parts exposed with the different PH light amounts.

All the toner images formed in the respective parts exposed with the different PH light amounts are transferred to the intermediate transfer belt 12 to become the toner images 602. The PH light amount increases in the order of the toner images 602D, 602C, 602B, and 602A. When the “PH light amount” is large, the “amount of the positive charges that spread laterally inside the photoreceptor 1” also increases, and as a result, the “line width of the toner image” also increases. Since the toner image 602 is assembly of the thin lines, when the “line width of the toner image 602” increases, the “density of the toner image 602” similarly increases.

The density sensor 55 detects the densities of the toner images 602 on the intermediate transfer belt 12. The controller 50 may obtain “the change amount of the density of the toner images when the PH light amount is changed” by comparing the densities of the toner images 602A, 602B, 602C, and 602D.

FIG. 7 is a view illustrating an example of the change amount of the density of the toner images of the photoreceptor 1 when the PH light amount is changed. A graph 701 illustrates “the change amount of the density of the toner images when the PH light amount is changed” of the photoreceptor 1C having a thin OCL. A graph 702 illustrates “the change amount of the density of the toner images when the PH light amount is changed” of the photoreceptor 1D laving a thick OCL.

Points 703A, 703B, 703C, and 703D indicate the densities when the toner images 602A, 602B, 602C, and 602D are detected by the density sensor 55, respectively. The graphs 701 and 702 are obtained based on the points 703A, 703B, 703C, and 703D. As is understood when comparing the graphs 701 and 702, the thicker the OCL, the larger “the change amount of the density of the toner images when the PH light amount is changed”.

Note that, although the controller 50 changes the PH light amount in four steps and detects the densities of the toner images for respective PH light amounts in this embodiment, the number of times of detection is not limited to this. When the controller 50 changes the PH light amount in more steps and detects the densities of the toner images for the respective PH light amounts, detection accuracy is improved accordingly. The controller 50 may detect the densities of the toner images for the PH light amounts in at least two steps.

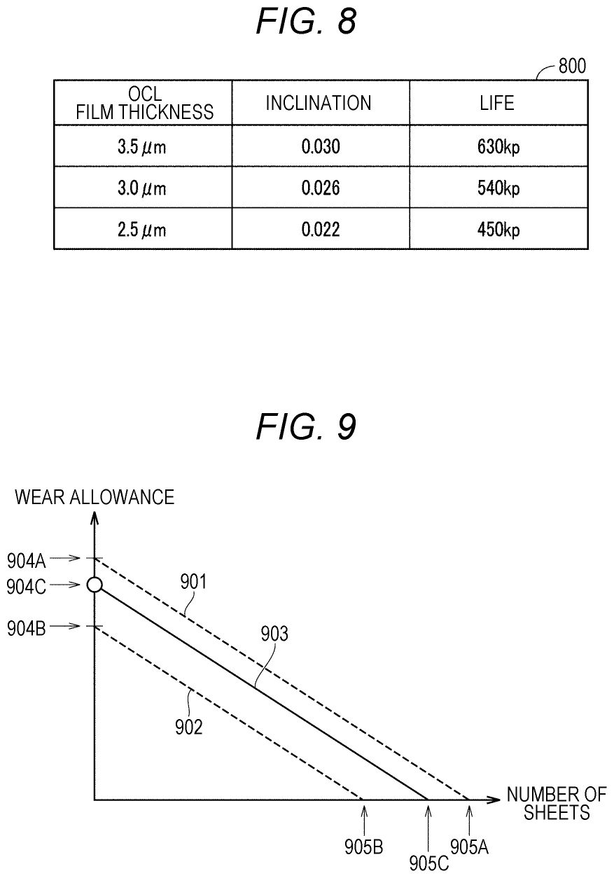

FIG. 8 is a view illustrating an example of a relationship between the OCL film thickness, the change amount of the density of the toner images when the PH light amount is changed, and the life of the photoreceptor 1. A table 800 includes association information obtained by associating the OCL film thickness, an inclination, and the life of the photoreceptor 1. The inclination is the inclination of the graphs 701 and 702 in FIG. 7 and corresponds to “the change amount of the density of the toner images when the PH light amount is changed”. The storage 51 stores the table 800 including the association information with respect to several types of OCL film thicknesses. In the illustration in FIG. 8, the table 800 includes the association information with respect to three types of OCL film thicknesses, but may also include the association information with respect to more types of OCL film thicknesses.

The controller 50 compares the “change amount of the density of the toner images when the PH light amount is changed (hereinafter referred to as an “actual inclination”)” obtained by measurement by the density sensor 55 with the “inclination” for each OCL film thickness included in the table 800, thereby predicting the life of the photoreceptor 1.

In one aspect, the controller 50 may compare the measured “actual inclination” with the “inclination” for each OCL film thickness included in the table 800 and determine the “OCL film thickness and life” corresponding to the closest “inclination” as an estimated value of the life. In another aspect, the controller 50 may calculate the life corresponding to the “actual inclination” based on the measured “actual inclination” and the contents of the table 800. For example, if “actual inclination=0.028”, the controller 50 may obtain an intermediate value between the “OCL film thicknesses” and that between the “lives” corresponding to “inclination=0.030” and “inclination=0.026”.

When the photoreceptor 1 is used to some extent, lubricant covers the surface layer of the photoreceptor 1, so that surface resistance of the photoreceptor 1 might change. At the same time, surface roughness of the photoreceptor 1 might change to change the line width of the toner image. Due to these causes, accuracy of the life prediction of the photoreceptor 1 utilizing the toner image 602 might be deteriorated. Therefore, it is desirable that the controller 50 predicts the life of the photoreceptor 1 when the photoreceptor 1 is replaced (when the photoreceptor 1 is new).

In one aspect, the density sensor 55 may also detect the density of the toner image on the surface of the photoreceptor 1. In this case, the density sensor 55 detects the density of the toner image on the surface of each photoreceptor 1 for each color.

FIG. 9 is a view illustrating an example of the estimated life of the photoreceptor 1. A graph 901 illustrates the life prediction of the photoreceptor 1 in a case where this is assumed to be continuously used in a longest-lasting situation assumed. A graph 902 illustrates the life prediction of the photoreceptor 1 in a case where this is assumed to be continuously used in the most severe situation assumed. A graph 903 illustrates the life prediction of the photoreceptor 1 actually predicted by the method described with reference to FIGS. 6 to 8.

Points 904A, 904B, and 904C indicate the wear allowance (OCL film thickness) when the photoreceptor 1 is new (when the number of printed sheets is 0) in the graphs 901, 902, and 903, respectively. The point 904A indicates a thickness of the thickest OCL assumed, and the point 904B indicates a thickness of the thinnest OCL assumed. The point 904C is the OCL film thickness estimated by the measurement. Points 905A, 905B, and 905C indicate a state in which the wear allowance of the photoreceptor 1 does not remain, that is, the photoreceptor 1 is used to its limit.

The controller 50 may keep a printing quality by predicting the life of the photoreceptor 1 based on the graph 902. However, since a difference in the life (difference in the printable number of sheets) due to the difference in the OCL film thickness is large, in many cases, it is expected that the photoreceptor 1 is replaced even though this may still print sufficiently.

In order to improve this waste, in this embodiment, the controller 50 predicts the OCL film thickness of the photoreceptor 1 (wear allowance at the point 904C) and the life of the photoreceptor 1 (estimates the number of printed sheets at the point 905C) by the method described with reference to FIGS. 6 to 8.

In this manner, the controller 50 may count the actual number of printed sheets, and display an instruction to replace the photoreceptor 1 on a monitor (not illustrated) of the image forming apparatus 100 at a time point when a count value reaches the printable number of sheets of the photoreceptor 1. In one aspect, the controller 50 may output the instruction to replace the photoreceptor 1 at a time point when a difference between the actual number of printed sheets and the printable number of sheets of the photoreceptor 1 is equal to or smaller than a predetermined number of sheets. A certain number herein may be 1,000, for example, but is not limited thereto. In one aspect, the controller 50 may notify a computer of a user and the like of the image forming apparatus 100 of the instruction to replace the photoreceptor 1 via a network.

In one aspect, in a case where the controller 50 detects that the photoreceptor 1 is replaced, this may display information to encourage the user to predict the life of the newly set photoreceptor 1 on the monitor. In one aspect, in a case where the controller 50 detects that the photoreceptor 1 is replaced, this may automatically start predicting the life of the newly set photoreceptor 1.

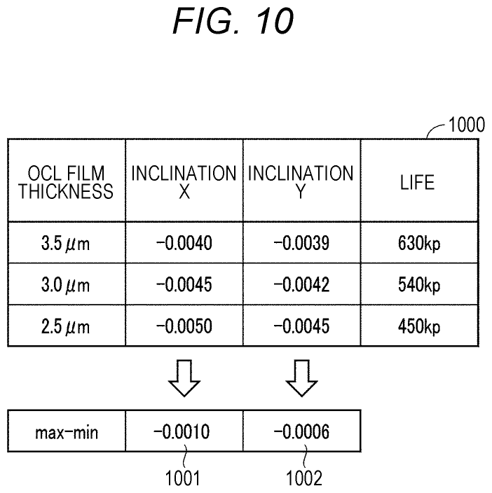

FIG. 10 is a view illustrating an example of a relationship between a rotational speed of the photoreceptor 1 and the inclination (change amount of the density of the toner images when the PH light amount is changed). A table 1000 associates the OCL film thickness, an inclination X, an inclination Y, and the life of the photoreceptor 1. Unlike the table 800, the table 1000 includes the two inclinations X and Y.

The inclination X is the inclination obtained by the controller 50 by rotating the photoreceptor 1 at a rotational speed half as high as that at the time of printing. The inclination Y is the inclination obtained by the controller 50 by rotating the photoreceptor 1 at the sane rotational speed as that at the time of printing. The PH light amount when obtaining the inclinations X and Y is the same.

A numerical value 1001 is a difference between a maximum value and a minimum value of the inclination X. A numerical value 1002 is a difference between a maximum value and a minimum value of the inclination Y. As is understood from the numerical values 1001 and 1002, the lower the rotational speed of the photoreceptor 1, the larger the change amount of the inclination by the difference in the OCL film thickness. This is because, the lower the rotational speed, the longer a time from when the latent image is formed on the photoreceptor until the toner image is formed. The longer this time, the larger the lateral flow of the positive changes in FIG. 3, and the greater the inclination. As a result, the accuracy of the life prediction of the photoreceptor 1 is increased.

In a case where the controller 50 changes the rotational speed of the photoreceptor 1 and performs the life prediction of the photoreceptor 1, the storage 51 must store the table 1000 including correspondence between the inclination and the OCL film thickness for each speed. The controller 50 rotates the photoreceptor 1 at the rotational speed lower than that at the time of printing and refers to the inclination corresponding to the rotational speed from the table 1000, thereby performing the life prediction of the photoreceptor 1.

Note that, in this embodiment, the controller 50 controls the rotational speed of the photoreceptor 1 to be half the rotational speed at the time of printing when the inclination of the photoreceptor 1 is obtained; however, the rotational speed of the photoreceptor 1 does not need to be half the rotational speed at the time of printing. The controller 50 may also appropriately set the rotational speed of the photoreceptor 1 when obtaining the inclination of the photoreceptor 1.

The OCL film thickness might vary in a longitudinal direction of the photoreceptor 1. Therefore, in one aspect, the controller 50 may perform the life prediction of the photoreceptor 1 according to this embodiment in a plurality of locations in the longitudinal direction of the photoreceptor 1, and determine the smallest of the lives estimated at the respective locations as the life of the photoreceptor 1, thereby improving the accuracy of the life prediction.

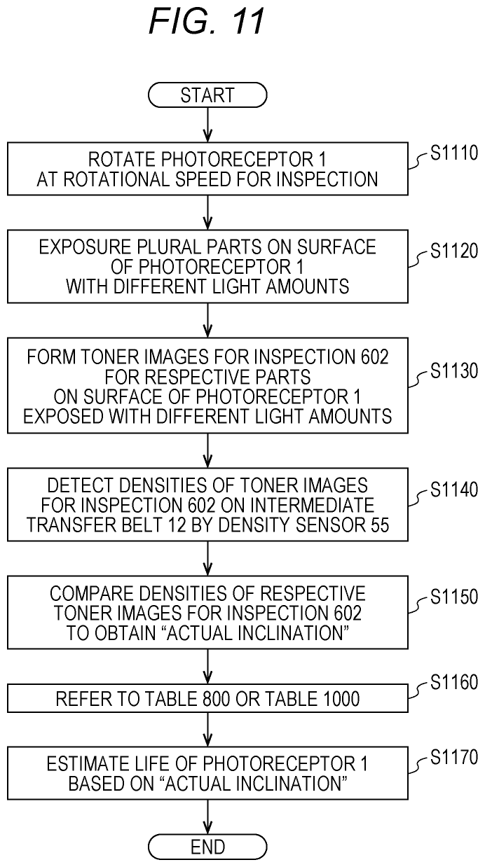

FIG. 11 is a view illustrating an example of a process of the life prediction of the photoreceptor 1. In one aspect, the controller 50 may read to execute a program for performing the process in FIG. 11 from the storage 51.

At step S1110, the controller 50 changes the rotational speed of the photoreceptor 1 to be lower than that at the time of printing before forming the toner image for inspection 602 on the photoreceptor 1. Note that, if the “actual inclination” is sufficiently large even in a case where the photoreceptor 1 rotates at the rotational speed at the time of printing, the controller 50 does not need to perform the process at step S1110.

At step S1120, the controller 50 allows the exposure device 3 to expose a plurality of parts on the surface of the photoreceptor 1 with different light amounts. Note that the charger 2 charges the surface of the photoreceptor 1 before the exposure.

At step S1130, the controller 50 allows the developer 4 to form the toner images for inspection 602 for the respective parts of the surface of the photoreceptor 1 exposed with the different light amounts. Next, the toner images for inspection 602 formed on the photoreceptor 1 are transferred to the intermediate transfer belt 12.

At step S1140, the controller 50 obtains an output from the density sensor 55, and detects the densities of the respective toner images for inspection 602 on the intermediate transfer belt 12.

At step S1150, the controller 50 compares the densities of the toner images for inspection 602 to obtain the “actual inclination”.

At step S1160, the controller 50 refers to the table 800 or the table 1000. The controller 50 refers to the table 1000 in a case where the rotational speed of the photoreceptor 1 is set to be lower than the rotational speed at the time of printing. Otherwise, the controller 50 refers to the table 800.

At step S1170, the controller 50 estimates the life of the photoreceptor 1 based on the change amount “actual inclination” of the density of the toner images for inspection caused by the change in the light amount of the exposure device 3. In one aspect, the controller 50 may compare the measured “actual inclination” with the “inclination” for each OCL film thickness included in the table 800 or 1000 and make the “OCL film thickness and life” corresponding to the closest “inclination” as an estimated value of the life. In another aspect, the controller 50 may calculate the life corresponding to the “actual inclination” based on the measured “actual inclination” and the contents of the table 800 or the table 1000. For example, if “actual inclination=0.028”, the controller 50 may obtain an intermediate value between the “OCL film thicknesses” and that between the “lives” corresponding to “inclination=0.030” and “inclination=0.026” in the table 800.

As described above, according to the image forming apparatus 100 according to this embodiment, the life of the photoreceptor 1 with variation in the OCL film thickness at the time of manufacture may be predicted based on the change amount of the density of the toner images caused by clanging the PH light of the exposure device 3. As a result, the image forming apparatus 100 may output an alert for replacement after printing an appropriate number of sheets in accordance with the life of the photoreceptor 1, and a situation where the photoreceptor 1 is replaced even though this is still usable may be avoided.

### Second Embodiment

Next, a second embodiment is described. A hardware configuration of an image forming apparatus 100 according to the second embodiment is the same as that of the image forming apparatus 100 described in the first embodiment. Therefore, the description of the same configuration is not repeated. The image forming apparatus 100 according to this embodiment is different from that of the first embodiment in that a charging potential of a photoreceptor 1 is changed in place of PH light when a life of the photoreceptor 1 is predicted.

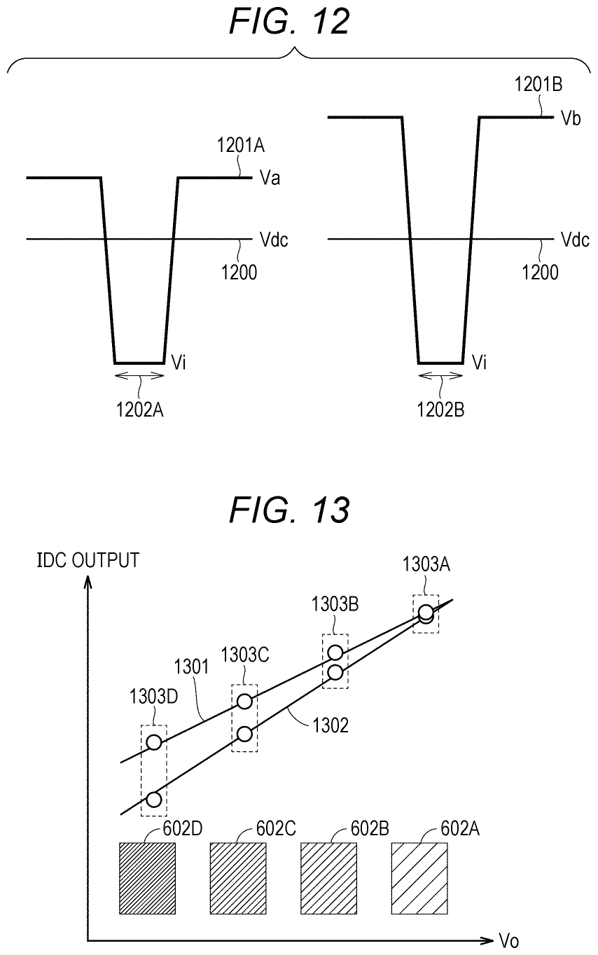

FIG. 12 is a view illustrating an example of a state in which the photoreceptor 1 charged with different voltages is exposed. In the controller 50, a charger 2 charges a surface of the photoreceptor 1. In the example illustrated in FIG. 12, a controller 50 charges the surface of the photoreceptor 1 so as to have two different types of charging potentials.

A potential 1200 is a reference potential V_{dc} of the surface of the photoreceptor 1. A potential 1201A is a potential when the charger 2 charges the surface of the photoreceptor 1 with a voltage Vₐ. A potential 1201B is a potential when the charger 2 charges the surface of the photoreceptor 1 with a voltage V_{b}. The potential 1201B has a higher absolute value of the potential than the potential 1201A.

Next, the controller 50 allows an exposure device 3 to expose a part of the surface of the photoreceptor 1. A part 1202A is a portion in which the surface of the photoreceptor 1 having the potential 1201A is exposed. A part 1202B is a portion in which the surface of the photoreceptor 1 having the potential 1201B is exposed. The potentials of the parts 1202A and 1202B are both Vᵢ.

When the surface of the charged photoreceptor 1 is exposed, the potential becomes Vᵢ. However, the potential of the exposed part does not fall vertically but falls with a slight inclination. Therefore, in a case where this is exposed from a higher potential, an area of an exposed portion becomes smaller. Therefore, the area of the part 1202B is smaller than the area of the part 1202A. Therefore, in a case where the controller 50 tries to form a toner image formed of thin lines on the surface of the photoreceptor 1, if the number of dots is fixed, the higher the absolute value of the charging potential of the photoreceptor 1, the smaller the area of the exposed portion, so that the narrower the line width of the thin line.

A change amount of the line width of the toner image accompanying the change in the charging potential of the photoreceptor 1 increases as a film thickness of an OCL increases. Therefore, as in FIGS. 6 to 8, the controller 50 may form toner images for inspection 602 while changing the charging potential of the photoreceptor 1 in place of the PH light amount, and examine a change amount of density, thereby predicting the life of the photoreceptor 1.

FIG. 13 is a view illustrating an example of the change amount of the density of the toner images on the photoreceptor 1 when the charging potential of the photoreceptor 1 is changed. A graph 1301 illustrates “the change amount of the density of the toner images when the charging potential of the photoreceptor 1 is changed” of a photoreceptor 1E having a thin OCL. A graph 1302 illustrates “the change amount of the density of the toner images when the charging potential of the photoreceptor 1 is changed” of a photoreceptor 1F having a thick OCL.

Points 1303A, 1303B, 1303C, and 1303D indicate the densities when toner images 602A, 602B, 602C, and 602D are detected by a density sensor 55, respectively. The graphs 1301 and 1302 are obtained based on the points 1303A, 1303B, 1303C, and 1303D. As is understood when comparing the graphs 1301 and 1302, the thicker the OCL, the larger “the change amount of the density of the toner images when the charging potential of the photoreceptor 1 is changed”.

Note that, although the controller 50 changes the charging potential of the photoreceptor 1 in four steps and detects the densities of the toner images for the respective charging potentials in this embodiment, the number of times of detection is not limited to this. When the controller 50 changes the charging potential of the photoreceptor 1 in more steps and detects the densities of the toner images for the charging potentials of the photoreceptor 1, detection accuracy is improved accordingly. The controller 50 may detect the densities of the toner images for the charging potentials of the photoreceptor 1 in at least two steps.

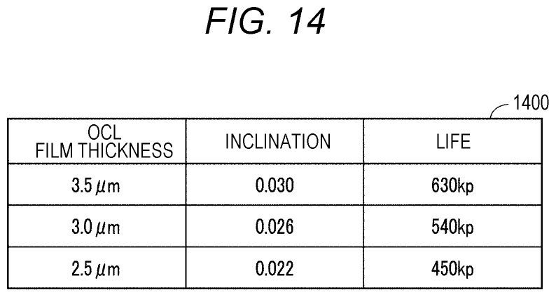

FIG. 14 is a view illustrating an example of a relationship between the film thickness of the OCL, the change amount of the density of the toner images when the charging potential of the photoreceptor 1 is changed, and the life of the photoreceptor 1. A table 1400 includes association information obtained by associating the film thickness of the OCL, an inclination, and the life of the photoreceptor 1. The inclination is the inclination of the graphs 1301, 1302 and the like in FIG. 13 and corresponds to “the change amount of the density of the toner images when the charging potential of the photoreceptor 1 is changed”. A storage 51 stores the table 1400 including the association information for several types of OCL film thicknesses. In the example of FIG. 14, the table 1400 includes the association information for three types of OCL film thicknesses, but may also include the association information for more types of OCL film thicknesses.

The controller 50 compares the change amount “actual inclination” of the density of the toner images when the charging potential of the photoreceptor 1 obtained by the measurement by the density sensor 55 is changed with the “inclination” of the table 1400 in the storage 51, thereby predicting the life of the photoreceptor 1.

In one aspect, the controller 50 may compare the measured “actual inclination” with the “inclination” in the table 1400 and determine the “OCL film thickness and life” corresponding to the closest “inclination” as an estimated value of the life. In one aspect, the controller 50 may calculate the life corresponding to the “actual inclination” based on the measured “actual inclination” and the contents of the table 1400. For example, if “actual inclination=0.028”, the controller 50 may obtain an intermediate value between the “OCL film thicknesses” and that between the “lives” corresponding to “inclination=0.030” and “inclination=0.026”.

Note that, it is desirable that the controller 50 predicts the life of the photoreceptor 1 when the photoreceptor 1 is replaced (when the photoreceptor 1 is new). When the photoreceptor 1 is used to some extent, a surface layer of the photoreceptor 1 is covered with lubricant (change in surface resistance), and surface roughness of the photoreceptor 1 is changed, so that a cause to change the line width of the toner image other than the OCL film thickness might occur. As a result, accuracy of the life prediction of the photoreceptor 1 using the toner image 602 is lowered.

In one aspect, the density sensor 55 may also detect the density of the toner image on the surface of the photoreceptor 1. In this case, the density sensor 55 detects the density of the toner image on the surface of each photoreceptor 1 for each toner color.

In one aspect, in a case where the controller 50 lowers a rotational speed of the photoreceptor 1 and estimates the OCL film thickness, the storage 51 must store the table including correspondence between the inclination for each speed and the OCL film thickness. The controller 50 rotates the photoreceptor 1 at the rotational speed lower than that at the time of printing and refers to the inclination corresponding to the rotational speed from the table, thereby performing the life prediction of the photoreceptor 1.

In one aspect, the controller 50 may obtain the change amount of the density of the toner images when both the PH light amount and the charging potential of the photoreceptor 1 are changed. In this case, the inclination of the table 1400 means the change amount of the density of the toner image when both the PH light amount and the charging potential of the photoreceptor 1 are changed.

As described above, the controller 50 may count the actual number of printed sheets, and display an instruction to replace the photoreceptor 1 on a monitor of the image forming apparatus 100 at a time point when a count value reaches the printable number of sheets of the photoreceptor 1. In one aspect, the controller 50 may output the instruction to replace the photoreceptor 1 at a time point when a difference between the actual number of printed sheets and the printable number of sheets of the photoreceptor 1 is equal to or smaller than a predetermined number of sheets. A certain number herein may be 1,000, for example, but is not limited thereto. In one aspect, the controller 50 may notify a computer of a user and the like of the image forming apparatus 100 of the instruction to replace the photoreceptor 1 via a network.

In one aspect, in a case where the controller 50 detects that the photoreceptor 1 is replaced, this may display information to encourage the user to estimate the life of the newly set photoreceptor 1 on the monitor. In one aspect, in a case where the controller 50 detects that the photoreceptor 1 is replaced, this may automatically start estimating the life of the newly set photoreceptor 1.

The OCL film thickness might vary in a longitudinal direction of the photoreceptor. Therefore, in one aspect, the controller 50 may perform the life prediction of the photoreceptor 1 according to this embodiment in a plurality of locations in the longitudinal direction, and determine the smallest of the lives estimated at the respective locations as the life of the photoreceptor 1, thereby improving the accuracy of the life prediction.

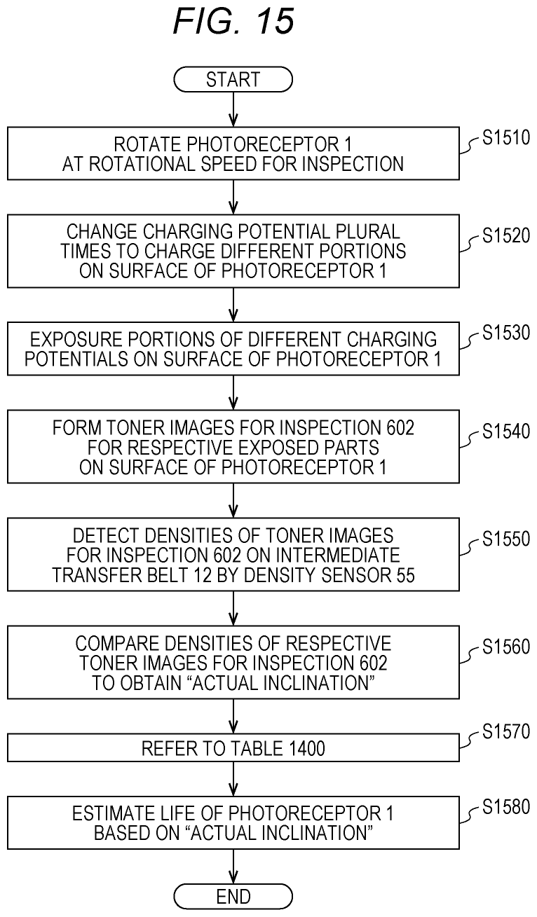

FIG. 15 is a view illustrating an example of a process of the life prediction of the photoreceptor 1. In one aspect, the controller 50 may read to execute a program for performing the process in FIG. 15 from the storage 51.

At step S1510, the controller 50 changes the rotational speed of the photoreceptor 1 to be lower than that at the time of printing before forming the toner image for inspection 602 on the photoreceptor 1. Note that, if the “actual inclination” is sufficiently large even in a case where the photoreceptor 1 rotates at the rotational speed at the time of printing, the controller 50 does not need to perform the process at step S1510.

At step S1520, the controller 50 allows the charger 2 to charge different portions of the surface of the photoreceptor 1 while changing the charging potential a plurality of times.

At step S1530, the controller 50 allows the exposure device 3 to expose the portions having different charging potentials on the surface of the photoreceptor 1.

At step S1540, the controller 50 allows a developer 4 to form the toner images for inspection 602 for the respective exposed parts of the surface of the photoreceptor 1. Next, the toner images for inspection 602 formed on the photoreceptor 1 are transferred to the intermediate transfer belt 12.

At step S1550, the controller 50 obtains an output from the density sensor 55, and detects the densities of the respective toner images for inspection 602 on the intermediate transfer belt 12.

At step S1560, the controller 50 compares the densities of the toner images for inspection 602 to obtain the “actual inclination”.

At step S1570, the controller 50 refers to the table 1400. Note that, in a case where the controller 50 sets the rotational speed of the photoreceptor 1 to be lower than the rotational speed at the time of printing, the table 1400 needs to include the “OCL film thickness”, “inclination”, and “life” for each speed.

At step S1580, the controller 50 estimates the life of the photoreceptor 1 based on the change amount “actual inclination” of the density of the toner images for inspection caused by the change in the clanging potential of the photoreceptor 1. In one aspect, the controller 50 may compare the measured “actual inclination” with the “inclination” for each OCL film thickness included in the table 1400 and determine the “OCL film thickness and life” corresponding to the closest “inclination” as an estimated value of the life. In another aspect, the controller 50 may calculate the life corresponding to the “actual inclination” based on the measured “actual inclination” and the contents of the table 1400.

As described above, according to the image forming apparatus 100 according to this embodiment, the life of the photoreceptor 1 with variation in the OCL film thickness at the time of manufacture may be predicted based on the change amount of the density of the toner images caused by changing the charging potential of the photoreceptor 1. As a result, the image forming apparatus 100 may output an alert for replacement after printing an appropriate number of sheets in accordance with the life of the photoreceptor 1, and a situation where the photoreceptor 1 is replaced even though this is still usable may be avoided.

### Third Embodiment

Next, a third embodiment is described. A hardware configuration of an image forming apparatus 100 according to the third embodiment is the same as that of the image forming apparatus 100 described in the above-described embodiments. Therefore, the description of the same configuration is not repeated. The image forming apparatus 100 according to this embodiment differs from that of the above-described embodiment in that a life of a photoreceptor 1 is predicted under a plurality of environments.

As described above, a toner image formed by the photoreceptor 1 provided with an OCL has a line width thicker than that of the toner image formed by the conventional photoreceptor. A reason that the line width becomes thick is that volume resistance of the OCL is smaller than that of a surface of the conventional photoreceptor. The volume resistance of the OCL changes with temperature and humidity. In particular, the volume resistance of the OCL is susceptible to humidity. In a case where the humidity is high, a surface layer of the OCL absorbs moisture and the resistance decreases, so that the line width becomes thicker.

When the volume resistance of the OCL changes, the “inclination (the change amount of the density of the toner images when the PH light amount is changed)” illustrated in FIG. 8 and the “inclination (the change amount of the density of the toner image when the charging potential of the photoreceptor 1 is changed)” illustrated in FIG. 14 change.

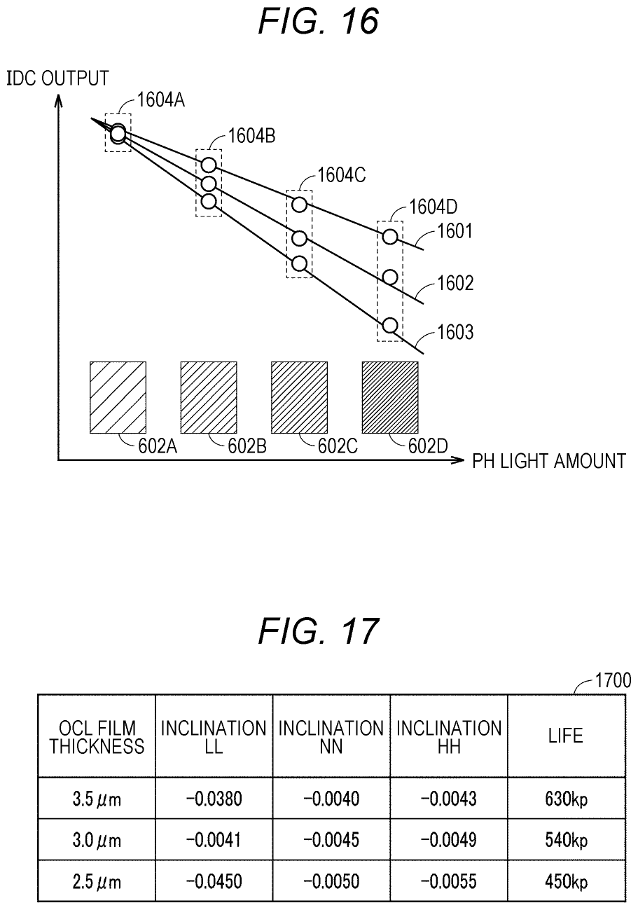

FIG. 16 is a view illustrating an example of an effect of the change in the volume resistance of the OCL for each environment. A graph 1601 illustrates life prediction of the photoreceptor 1 in an environment of “low temperature and low humidity”. A graph 1602 illustrates life prediction of the photoreceptor 1 in an environment of “middle temperature and middle humidity”. A graph 1603 illustrates life prediction of the photoreceptor 1 in an environment of “high temperature and high humidity”. An OCL film thickness of the photoreceptors 1 in the graphs 1601, 1602, and 1603 is the same.

Points 1604A, 1604B, 1604C, and 1604D indicate the densities when the toner images 602A, 602B, 602C, and 602D are detected by the density sensor 55, respectively. The graphs 1601, 1602, and 1603 are obtained based on the points 1604A, 1604B, 1604C, and 1604D. As is understood by comparing the graphs 1601, 1602, and 1603, the “inclination” increases as the temperature and humidity increase.

In one aspect, the controller 50 may obtain the change amount of the density of the toner images when the PH light amount is changed, or obtain the change amount of the density of the toner image when the charging potential of the photoreceptor 1 is changed, or combine both of them.

Note that, although a controller 50 changes the PH light amount or the charging potential of the photoreceptor 1 in four steps and detects the densities of the toner images for the respective PH light amounts or the respective charging potentials of the photoreceptor 1 in this embodiment, the number of times of detection is not limited to this. When the controller 50 changes the density of the toner images in more steps and detects the changed densities of the toner images, detection accuracy is improved accordingly. The controller 50 may detect the densities of the toner images for the PH light amounts or the charging potentials of the photoreceptor 1 in at least two steps.

As described above, as environmental information “temperature and humidity” changes, the “inclination” also changes. Therefore, in order to appropriately obtain the life of the photoreceptor 1 even in a case where the temperature and humidity change, the controller 50 desirably refers to a table of a correlation between the “inclination” for each environmental information such as “low temperature and low humidity” and “high temperature and high humidity” and the “OCL film thickness and life”.

FIG. 17 is a view illustrating an example of the correlation among the OCL film thickness, the inclination for each environment, and the life of the photoreceptor 1. A table 1700 includes association information obtained by associating the OCL film thickness, the inclination for each environment, and the life of the photoreceptor 1. The inclination is the inclination of the graphs 1601, 1602, and 1603 in FIG. 16 and corresponds to “the change amount of the density of the toner images when the PH light amount is changed”.

An “inclination LL” is an inclination under a “low temperature and low humidity” environment. An “inclination NN” is an inclination under a “medium temperature and medium humidity” environment. An “inclination HH” is an inclination under a “high temperature and high humidity” environment. For example, the inclination of the photoreceptor 1 having the OCL film thickness of “3.5 μm” under the “low temperature and low humidity” environment is “−0.0380”.

Note that, in this embodiment, for example, “low temperature and low humidity” means “temperature=10 degrees and humidity=15%”, “medium temperature and medium humidity” means “temperature=23 degrees and humidity=65%”, and “high temperature and high humidity” means “temperature=30 degrees and humidity=85%”; however, setting of the temperature and humidity is not limited thereto.

A storage 51 stores the table 1700 including the association information for several types of OCL film thicknesses. In the example of FIG. 17, the table 1700 includes the association information for three types of OCL film thicknesses, but may also include the association information for more types of OCL film thicknesses.

The controller 50 may compare the “change amount of the density of the toner images when the PH light amount is changed or the change amount (actual inclination) of the density of the toner images when the charging potential of the photoreceptor 1 is changed” obtained by the measurement by a density sensor 55 with the “inclination” under a certain environment of the table 1700 of the storage 51, thereby predicting the life of the photoreceptor 1. The controller 50 selects an inclination to be compared from the table 1700 based on a detection result of an environmental sensor (not illustrated) provided in the image forming apparatus 100. The environmental sensor includes, for example, a temperature sensor and a humidity sensor.

In one aspect, the controller 50 may compare the measured “actual inclination” with the “inclination” in the table 1700 and determine the “OCL film thickness and life” corresponding to the closest “inclination” as an estimated value of the life. In one aspect, the controller 50 may also calculate the “OCL film thickness” and “life” corresponding to the “actual inclination” based on the measured “actual inclination” and the contents of the table 1700.

Note that, it is desirable that the controller 50 predicts the life of the photoreceptor 1 when the photoreceptor 1 is replaced (when the photoreceptor 1 is new). When the photoreceptor 1 is used to some extent, a surface layer of the photoreceptor 1 is covered with lubricant (change in surface resistance), and surface roughness of the photoreceptor 1 is changed, so that a cause to change the line width of the toner image other than the OCL film thickness might occur. As a result, accuracy of the life prediction of the photoreceptor 1 using the toner image 602 is lowered.

In one aspect, the density sensor 55 may also detect the density of the toner image on the surface of the photoreceptor 1. In this case, the density sensor 55 detects the density of the toner image on the surface of each photoreceptor 1 for each toner color.

As described above, the controller 50 may count the actual number of printed sheets, and display an instruction to replace the photoreceptor 1 on a monitor of the image forming apparatus 100 at a time point when a count value reaches the printable number of sheets of the photoreceptor 1. In one aspect, the controller 50 may output the instruction to replace the photoreceptor 1 at a time point when a difference between the actual number of printed sheets and the printable number of sheets of the photoreceptor 1 is equal to or smaller than a predetermined number of sheets. A certain number herein may be 1,000, for example, but is not limited thereto. In one aspect, the controller 50 may notify a computer of a user and the like of the image forming apparatus 100 of the instruction to replace the photoreceptor 1 via a network.

In one aspect, in a case where the controller 50 detects that the photoreceptor 1 is replaced, this may display information to encourage the user to estimate the life of the newly set photoreceptor 1 on the monitor. In one aspect, in a case where the controller 50 detects that the photoreceptor 1 is replaced, this may automatically start estimating the life of the newly set photoreceptor 1.

The OCL film thickness might vary in a longitudinal direction of the photoreceptor. Therefore, in one aspect, the controller 50 may perform the life prediction of the photoreceptor 1 according to this embodiment in a plurality of locations in the longitudinal direction, and determine the smallest of the lives estimated at the respective locations as the life of the photoreceptor 1, thereby improving the accuracy of the life prediction.

As described above, according to the image forming apparatus 100 according to this embodiment, the life of the photoreceptor 1 with variation in the OCL film thickness at the time of manufacture may be predicted based on the change amount of the density of the toner images caused by changing the PH light amount or the charging potential of the photoreceptor 1 even under different environments. As a result, the image forming apparatus 100 may output an alert for replacement after printing an appropriate number of sheets in accordance with the life of the photoreceptor 1, and a situation where the photoreceptor 1 is replaced even though this is still usable may be avoided.

### Fourth Embodiment

Next, a fourth embodiment is described. A hardware configuration of an image forming apparatus 100 according to the fourth embodiment is the same as that of the image forming apparatus 100 described in the above-described embodiments. Therefore, the description of the same configuration is not repeated. The image forming apparatus 100 according to this embodiment differs from that of the above-described embodiment in that a life of a photoreceptor 1 is predicted each time a certain number of sheets are printed.

As described above, it is desirable that a controller 50 predicts the life of the photoreceptor 1 when the photoreceptor 1 is replaced (when the photoreceptor 1 is new). When the photoreceptor 1 is used to some extent, a surface layer of the photoreceptor 1 is covered with lubricant (change in surface resistance), and surface roughness of the photoreceptor 1 is changed, so that a cause to change the line width of the toner image other than the OCL film thickness might occur. As a result, accuracy of the life prediction of the photoreceptor 1 using the toner image 602 is lowered.

However, if the image forming apparatus 100 prints only up to about half the life (printable number of sleets) of the photoreceptor 1, an effect of a factor that changes the line width of the toner image is small, and the controller 50 may predict the life of the photoreceptor 1.

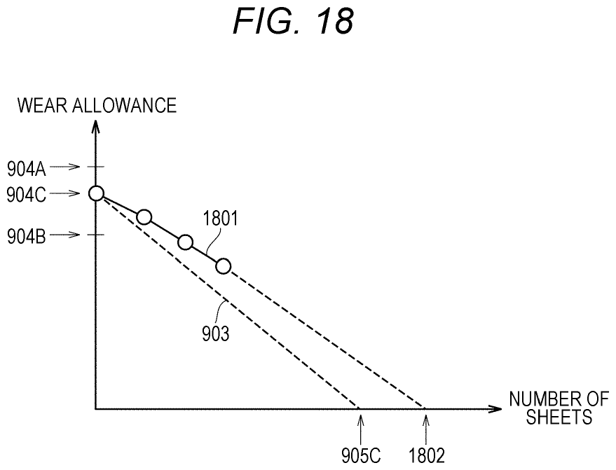

FIG. 18 is a view illustrating an example of a method of estimating the life of the photoreceptor 1 according to this embodiment. The controller 50 predicts the life of the photoreceptor 1 by the method illustrated in the first or second embodiment when the photoreceptor 1 is replaced. Next, each time a predetermined number of sheets are printed, the controller 50 may perform the life prediction of the photoreceptor 1 by the method illustrated in the first or second embodiment to correct the previous life prediction. A graph 1801 is obtained by correcting the life prediction of the graph 903 in FIG. 9.

In one aspect, since the life prediction after printing a certain number of sheets might include an error, the controller 50 may estimate a value of the predicted life to be smaller by multiplying a coefficient by the life of the photoreceptor 1 predicted by the method illustrated in the first and second embodiments.

In one aspect, the controller 50 may obtain the change amount of the density of the toner images when the PH light amount is changed, or obtain the change amount of the density of the toner image when the charging potential of the photoreceptor 1 is changed, or combine both of them. In one aspect, the controller 50 may refer to a table in which the OCL film thickness, the inclination for each environment, and the life of the photoreceptor 1 are associated in the life prediction of the photoreceptor 1.

As described above, the controller 50 may count the actual number of printed sheets, and display an instruction to replace the photoreceptor 1 on a monitor of the image forming apparatus 100 at a time point when a count value reaches the printable number of sheets of the photoreceptor 1. In one aspect, the controller 50 may output the instruction to replace the photoreceptor 1 at a time point when a difference between the actual number of printed sheets and the printable number of sheets of the photoreceptor 1 is equal to or smaller than a predetermined number of sheets. A certain number herein may be 1,000, for example, but is not limited thereto. In one aspect, the controller 50 may notify a computer of a user and the like of the image forming apparatus 100 of the instruction to replace the photoreceptor 1 via a network.

In one aspect, in a case where the controller 50 detects that the photoreceptor 1 is replaced, this may display information to encourage the user to estimate the life of the newly set photoreceptor 1 on a monitor of the image forming apparatus 100. In one aspect, in a case where the controller 50 detects that the photoreceptor 1 is replaced, this may automatically start estimating the life of the newly set photoreceptor 1.

The OCL film thickness might vary in a longitudinal direction of the photoreceptor. Therefore, in one aspect, the controller 50 may perform the life prediction of the photoreceptor 1 according to this embodiment in a plurality of locations in the longitudinal direction, and determine the smallest of the lives estimated at the respective locations as the life of the photoreceptor 1, thereby improving the accuracy of the life prediction.

As described above, according to the image forming apparatus 100 according to this embodiment, the life prediction is corrected while the number of printed sheets is small and the effect of the factor that changes the line width of the toner image is small. As a result, the image forming apparatus 100 may output an alert for replacement after printing an appropriate number of sheets in accordance with the life of the photoreceptor 1 estimated in further detail, and a situation where the photoreceptor 1 is replaced even though this is still usable may be avoided.

In still another aspect, the disclosed technical features may be summarized as follows, for example.

[Configuration 1]

A method of estimating a life of a photoreceptor of an image forming apparatus, including a step of changing a light amount of an exposure device a plurality of times to expose a plurality of parts on a surface of the photoreceptor with different light amounts, a step of allowing a developer to form toner images for inspection for respective parts on the surface of the photoreceptor exposed with the different light amounts, a step of detecting densities of the toner images for inspection transferred to an intermediate transfer belt based on an output from the density sensor, and a step of comparing the densities of the respective toner images for inspection to estimate a life of the photoreceptor based on a change amount of the densities of the toner images for inspection caused by a change in light amount of the exposure device.

[Configuration 2]

The method according to the configuration 1, further including a step of storing in advance association information in which the change amount of the densities of the toner images for inspection by the change in the light amount of the exposure device and the life of the photoreceptor are associated with each other, and a step of estimating the life of the photoreceptor by comparing the change amount of the densities obtained by comparing the densities of the respective toner images for inspection with the association information.

[Configuration 3]

A method including a step of allowing a charger to change a charging potential a plurality of tines to charge a surface of a photoreceptor, a step of allowing an exposure device to expose respective portions on a surface of the photoreceptor with different charging potentials, a step of allowing a developer to form toner images for inspection for respective exposed parts on the surface of the photoreceptor, a step of detecting densities of the toner images for inspection transferred to an intermediate transfer belt based on an output from the density sensor, and a step of comparing the densities of the respective toner images for inspection to estimate a life of the photoreceptor based on a change amount of the densities of the toner images for inspection caused by a change in the charging potential of the photoreceptor.

[Configuration 4]

The method according to the configuration 3, further including a step of storing association information in which the change amount of the densities of the toner images for inspection by the change in the charging potential of the photoreceptor and the life of the photoreceptor are associated with each other, and a step of estimating

the life of the photoreceptor by comparing the change amount of the densities of the toner images for inspection with the association information.

[Configuration 5]

The method according to the configuration 2 or 4, further including a step of storing a plurality of pieces of association information associated with a plurality of pieces of environmental information, and a step of obtaining the stored association information for comparing with the change amount of the densities of the toner images for inspection based on the environmental information obtained from the environmental sensor.

[Configuration 6]

The association information further includes information of a rotational speed of the photoreceptor. The method according to the configuration 2 or 4, further including a step of referring to the association information based on forming each toner image for inspection and rotating the photoreceptor at a speed included in the association information.

[Configuration 7]

The method according to the configuration 6, further including a step of setting the rotational speed of the photoreceptor to be lower than the rotational speed at the time of printing based on forming the toner images for inspection on the surface of the photoreceptor.

[Configuration 8]

The method according to any one of the configurations 1 to 7, further including a step of comparing three or more toner images for inspection in order to obtain the change amount of the densities of the toner images for inspection.

[Configuration 9]

The method according to any one of the configurations 1 to 8, further including a step of estimating the life of the photoreceptor based on the change amount of the densities of the toner images for inspection for each of a plurality of different sections in a longitudinal direction of the surface of the photoreceptor, and a step of determining a shortest life out of lives estimated for the plurality of different sections in the longitudinal direction of the surface of the photoreceptor as the life of the photoreceptor.

[Configuration 10]

The method according to any one of the configurations 1 to 9, further including a step of calculating an estimated value of a remaining printable number of media using the photoreceptor based on the life of the photoreceptor estimated based on the change amount of the densities of the toner images for inspection and the number of printed media before estimating the life of the photoreceptor.

[Configuration 11]

The life of the photoreceptor is an estimated value of the printable number of media using the photoreceptor. The method according to any one of the configurations 1 to 10, further including a step of comparing the number of printed sheets with the estimated value, and a step of displaying an instruction to replace the photoreceptor on a monitor based on a fact that a difference between the printed number of sheets and the estimated value is equal to or smaller than a predetermined number.

[Configuration 12]

The method according to the configuration 11, further including a step of displaying information that encourages a user to estimate the life of the photoreceptor on the monitor based on detection of replacement of the photoreceptor.

[Configuration 13]

The method according to the configuration 11, further including a step of estimating the life of the photoreceptor based on detection of replacement of the photoreceptor.

Although embodiments of the present invention have been described and illustrated in detail, the disclosed embodiments are made for purposes of illustration and example only and not limitation. The scope of the present invention should be interpreted by terms of the appended claims, and it is intended that equivalents of the scope of claims and all modifications within the scope are included.

What is claimed is:

1. An image forming apparatus comprising:
a photoreceptor that forms a toner image on a surface of the photoreceptor;
a charger that charges the surface of the photoreceptor;
an exposure device that exposes the surface of the photoreceptor;
a developer that supplies toner to the surface of the photoreceptor;
an intermediate transfer belt for transferring the toner image formed on the surface of the photoreceptor;
a density sensor that detects a density of the toner image on the intermediate transfer belt; and
a controller that controls the image forming apparatus,
wherein the controller
changes a light amount of the exposure device a plurality of times to expose a plurality of parts on the surface of the photoreceptor with different light amounts,
allows the developer to form toner images for inspection for respective parts on the surface of the photoreceptor exposed with the different light amounts,
detects densities of the toner images for inspection transferred to the intermediate transfer belt based on an output from the density sensor, and
compares the densities of the respective toner images for inspection to estimate a life of the photoreceptor based on a change amount of the densities of the toner images for inspection caused by a change in light amount of the exposure device.

2. The image forming apparatus according to claim 1, further comprising:
a storage that stores in advance association information in which the change amount of the densities of the toner images for inspection by the change in the light amount of the exposure device and the life of the photoreceptor are associated with each other,
wherein the controller estimates the life of the photoreceptor by comparing the change amount of the densities obtained by comparing the densities of the respective toner images for inspection with the association information.

3. An image forming apparatus comprising:
a photoreceptor that forms a toner image on a surface of the photoreceptor;
a charger that charges the surface of the photoreceptor;
an exposure device that exposes the surface of the photoreceptor;
a developer that supplies toner to the surface of the photoreceptor;
an intermediate transfer belt for transferring the toner image formed on the surface of the photoreceptor;
a density sensor that detects a density of the toner image on the intermediate transfer belt; and
a controller that controls the image forming apparatus,
wherein the controller
allows the charger to charge the surface of the photoreceptor while changing a charging potential a plurality of times,
allows the exposure device to expose respective portions with different charging potentials of the surface of the photoreceptor,
allows the developer to form toner images for inspection for respective exposed parts on the surface of the photoreceptor,
detects densities of the toner images for inspection transferred to the intermediate transfer belt based on an output from the density sensor, and
compares the densities of the respective toner images for inspection to estimate a life of the photoreceptor based on a change amount of densities of the toner images for inspection caused by a change in charging potential of the photoreceptor.

4. The image forming apparatus according to claim 3, further comprising:
a storage that stores association information in winch the change amount of the densities of the toner images for inspection by the change in the charging potential of the photoreceptor and the life of the photoreceptor are associated with each other,
wherein the controller estimates the life of the photoreceptor by comparing the change amount of the densities of the toner images for inspection with the association information.

5. The image forming apparatus according to claim 2, further comprising:
an environmental sensor that obtains environmental information inside the image forming apparatus,
wherein the storage stores a plurality of pieces of association information associated with a plurality of pieces of environmental information, and
the controller obtains the association information for comparing with the change amount of the densities of the toner images for inspection from the storage based on the environmental information obtained from the environmental sensor.

6. The image forming apparatus according to claim 2,
wherein the association information further includes information of a rotational speed of the photoreceptor, and
the controller refers to the association information based on forming each toner image for inspection and rotates the photoreceptor at a speed included in the association information.

7. The image forming apparatus according to claim 6,
wherein the controller sets the rotational speed of the photoreceptor to be lower than the rotational speed at the time of printing based on forming the toner images for inspection on the surface of the photoreceptor.

8. The image forming apparatus according to claim 1,
wherein the controller compares three or more toner images for inspection in order to obtain the change amount of the densities of the toner images for inspection.

9. The image forming apparatus according to claim 1,
wherein the controller estimates the life of the photoreceptor based on the change amount of the densities of the toner images for inspection for each of a plurality of different sections in a longitudinal direction of the surface of the photoreceptor, and
determines a shortest life out of lives estimated for the plurality of different sections in the longitudinal direction of the surface of the photoreceptor as the life of the photoreceptor.

10. The image forming apparatus according to claim 1,
wherein the controller calculates an estimated value of a remaining printable number of media using the photoreceptor based on the life of the photoreceptor estimated based on the change amount of the densities of the toner images for inspection and the number of printed media before estimating the life of the photoreceptor.

11. The image forming apparatus according to claim 1, further comprising:
a monitor that displays information,
wherein the life of the photoreceptor is an estimated value of the number of printable media using the photoreceptor, and
the controller compares the number of printed sheets with the estimated value, and
displays an instruction to replace the photoreceptor on the monitor based on a fact that a difference between the printed number of sheets and the estimated value is equal to or smaller than a predetermined number.

12. The image forming apparatus according to claim 11,
wherein the controller displays information that encourages a user to estimate the life of the photoreceptor on the monitor based on detection of replacement of the photoreceptor.

13. The image forming apparatus according to claim 11,
wherein the controller estimates the life of the photoreceptor based on detection of replacement of the photoreceptor.

14. The image forming apparatus according to claim 3,
wherein the controller compares three or more toner images for inspection in order to obtain the change amount of the densities of the toner images for inspection.

15. The image forming apparatus according to claim 3,
wherein the controller estimates the life of the photoreceptor based on the change amount of the densities of the toner images for inspection for each of a plurality of different sections in a longitudinal direction of the surface of the photoreceptor, and
determines a shortest life out of lives estimated for the plurality of different sections in the longitudinal direction of the surface of the photoreceptor as the life of the photoreceptor.

16. The image forming apparatus according to claim 3,
wherein the controller calculates an estimated value of a remaining printable number of media using the photoreceptor based on the life of the photoreceptor estimated based on the change amount of the densities of the toner images for inspection and the number of printed media before estimating the life of the photoreceptor.

17. The image forming apparatus according to claim 3, further comprising:
a monitor that displays information,
wherein the life of the photoreceptor is an estimated value of the number of printable media using the photoreceptor, and
the controller compares the number of printed sheets with the estimated value, and
displays an instruction to replace the photoreceptor on the monitor based on a fact that a difference between the printed number of sheets and the estimated value is equal to or smaller than a predetermined number.
